(19) United States
(12) Patent Application Publication
(10) Pub. No.: US 2025/0276432 A1
(43) Pub. Date: Sep. 4, 2025

(54) SOCKET HOLDER

(71) Applicant: CHUN NIEN PLASTIC LTD., Taichung City (TW)

(72) Inventor: CHI-TSAI CHANG, Taichung City (TW)

(21) Appl. No.: 19/066,595

(22) Filed: Feb. 28, 2025

(30) Foreign Application Priority Data
Mar. 1, 2024 (TW) 113202068

(51) Int. Cl. B25H 3/00

(52) U.S. Cl. CPC B25H 3/003

(57) ABSTRACT

A socket holder is provided, wherein the socket holder is provided includes: a base; and a positioning insertion member swingably disposed on the base and configured for a socket to be sleeved thereon. Whereby, the user can adjust the position of the socket by swinging the positioning insertion member to meet different usage requirements in various usage environments and occasions.

### BACKGROUND OF THE INVENTION

### Field of the Invention

The present invention relates to a storage device, particularly to a socket holder.

### Description of the Prior Art

Sockets are typically stored in a toolbox. This storage method often causes sockets to roll freely within the toolbox, leading to unnecessary collisions or getting stacked among numerous components, making them difficult to locate. Consequently, the industry later developed dedicated socket holders for storage. The holder includes a supporting column and an elastic piece that is swingable relative to the supporting post. A protrusion is formed on the elastic piece, and the protrusion is pressed tightly against the socket by the elastic pushing force of the elastic piece, thereby achieving a securing effect. The elastic piece can be compressed by external force to disengage the protrusion from the socket, allowing the socket to be retrieved.

However, in conventional socket holders, the supporting column used to engage with the socket is fixed to the holder body, which results in a fixed placement orientation of the socket. This setup does not allow users to adjust the usage angle as needed. Moreover, sockets are usually engaged or disengaged with the supporting post in an up-and-down manner, making them prone to unintended detachment due to unexpected external forces.

The present invention is, therefore, arisen to obviate or at least mitigate the above-mentioned disadvantages.

### SUMMARY OF THE INVENTION

The main object of the present invention is to provide a socket holder which allows the user to adjust the position of the socket by swinging the positioning insertion member to meet different usage requirements in various usage environments and occasions.

To achieve the above and other objects, a socket holder is provided, wherein the socket holder is provided includes: a base; and a positioning insertion member swingably disposed on the base and configured for a socket to be sleeved thereon.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is another exploded view of FIG. 2;

FIG. 4 is a cross-sectional view showing a socket engagement state in an exemplary embodiment of the present invention;

FIG. 5 is a side cross-sectional view showing a positioning insertion member in a first position according to an exemplary embodiment of the present invention.

FIG. 6 is a side cross-sectional view showing the positioning insertion member in a second position according to an exemplary embodiment of the present invention;

FIG. 7 is a top cross-sectional view relative to FIG. 5;

FIG. 8 is a top cross-sectional view relative to FIG. 6;

FIG. 9 is a perspective view showing the socket holder slidably disposed on a rail device according to an exemplary embodiment of the present invention; and

FIG. 10 is a cross-sectional view of another exemplary embodiment of the present invention showing a socket engagement state.

### DETAILED DESCRIPTION OF THE PREFERRED EMBODIMENTS

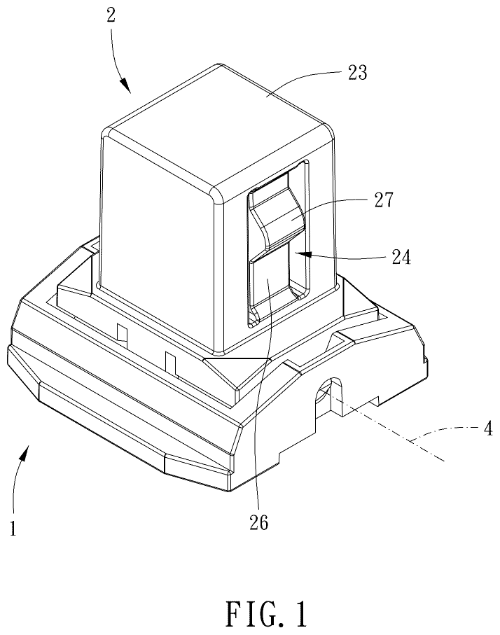

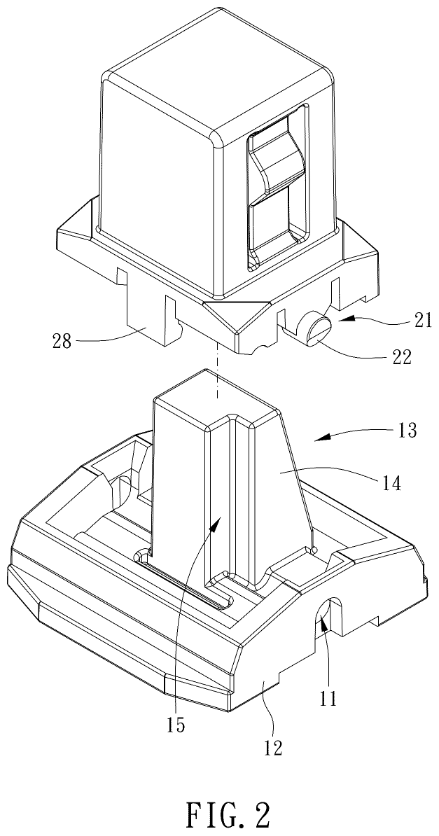

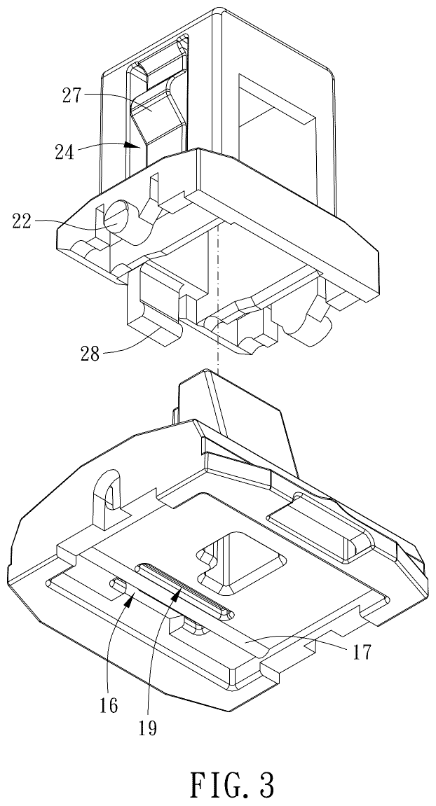

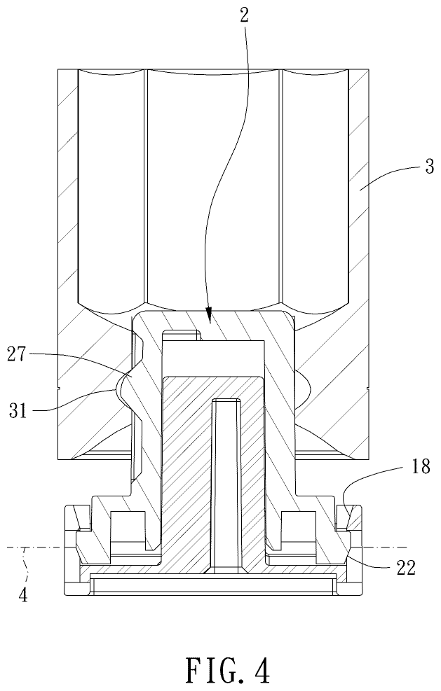

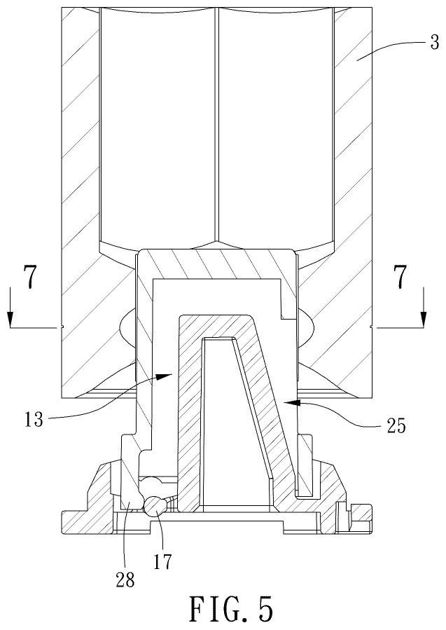

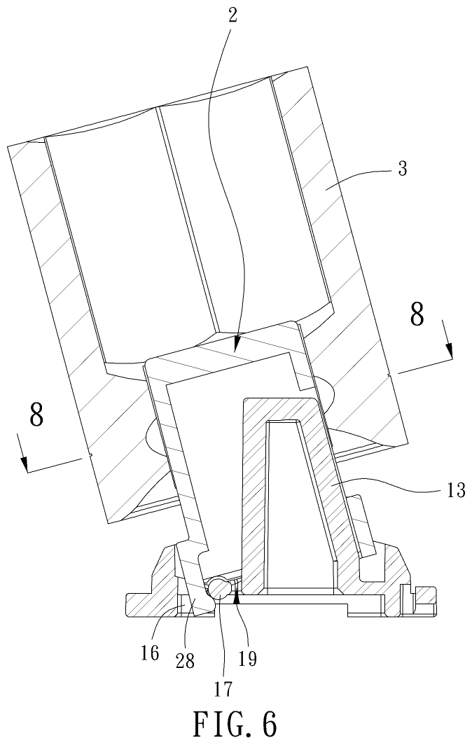

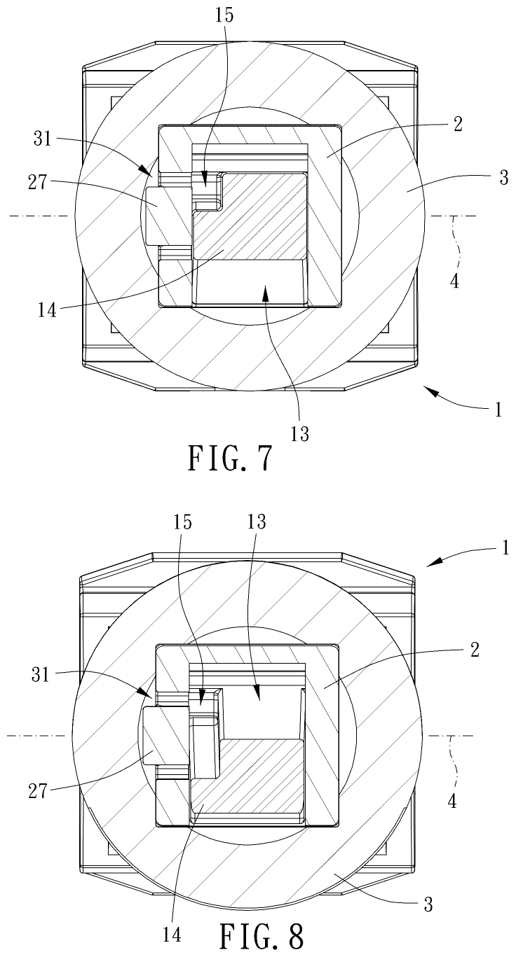

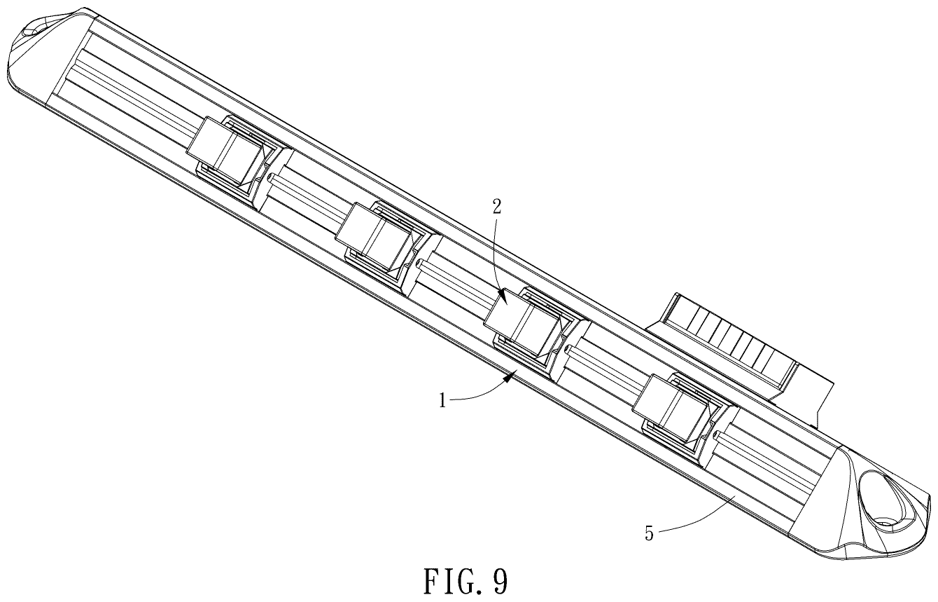

Please refer to FIGS. 1 to 9 for an exemplary embodiment of the present invention. A socket holder 1 of the present invention includes a base 1 and a positioning insertion member 2.

The base 1 is configured to slide on a rail device 5, and can be adjustably slid to change its relative position to meet the user's needs. The positioning insertion member 2 is swingably disposed on the base 1 for a socket 3 to be sleeved thereon. The user can swing and adjust the positioning insertion member 2 as needed, allowing the socket 3 to be oriented at different angles to meet usage requirements, such as positioning the socket 3 at a more convenient angle for easy removal.

Preferably, the positioning insertion member 2 is detachably connected to the base 1. When the positioning insertion member 2 experiences wear, deformation, or damage due to repeated engagement with the socket 3, the detachable design allows the user to simply replace the positioning insertion member 2, which is convenient and cost-saving.

Specifically, the positioning insertion member 2 includes a main body 23 and an elastic arm 26. The main body 23 includes a first through hole 24, an end of the elastic arm 26 is connected to the main body 23 and extends through the first through hole 24, and the other end of the elastic arm 26 is a free end and includes a first positioning portion 27. When the positioning insertion member 2 is inserted in the socket 3, the first positioning portion 27 is configured to engage with a second positioning portion 31 of the socket 3. For example, the first positioning portion 27 may be a protruding portion, and the second positioning portion 31 may be a recessed portion.

More specifically, the positioning insertion member 2 further includes two first pivot connection portions 21. The two first pivot connection portions 21 are disposed on opposite sides of the positioning insertion member 2, and the base 1 includes two second pivot connection portions 11. The two first pivot connection portions 21 are respectively pivotally connected to the two second pivot connection portions 11 so that the positioning insertion member 2 can swing relative to the base 1. For example, each of the two first pivot connection portions 21 is a protruding column, and each of the two second pivot connection portions 11 is a pivot hole.

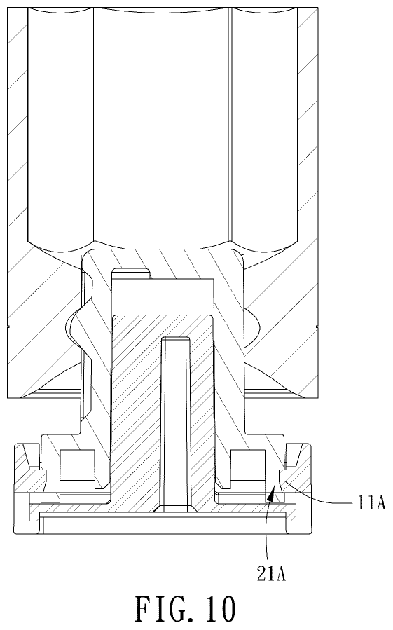

More specifically, the positioning insertion member 2 further includes two first pivot connection portions 21, the two first pivot connection portions 21 are disposed on opposite sides of the positioning insertion member 2, the base 1 includes two second pivot connection portions 11, and the two first pivot connection portions 21 are respectively pivotally connected to the two second pivot connection portions 11 so that the positioning insertion member 2 can pivotally swing relative to the base 1. For example, each of the two first pivot connection portions 21 is a protruding column, and each of the two second pivot connection portions 11 is a pivot hole, and the first pivot connection portions 21 are detachably inserted in the second pivot connection portions 11. Alternatively, as shown in another exemplary embodiment in FIG. 10, the first pivot connection portion 21A is a pivot hole, and the second pivot connection portion 11A is a protruding column, and the first pivot connection portion 21A can be detachably inserted into the second pivot connection portion 11A.

Please further refer to the exemplary embodiment in FIGS. 1 to 9, each of the two first pivot connection portions 21 includes a first inclined surface 22, and the base 1 includes two second inclined surfaces 18. When the positioning insertion member 2 is assembled to the base 1, the first inclined surfaces 22 of the two first pivot connection portions 21 respectively slidably abut against the two second inclined surfaces 18 so that the first pivot connection portions 21 can smoothly slide into the second pivot connection portions 11.

It is noted that in the exemplary embodiment, the swinging position of the positioning insertion member 2 and the positioning relationship of the socket 3 are combined, thus forming a mechanism where the locking or releasing of the socket 3 can be controlled through the swinging of the positioning insertion member 2. More specifically, the base 1 includes a base portion 12 and a wall portion 13, the wall portion 13 protrudes from the base portion 12, and the positioning insertion member 2 is connected to the base portion 12 and is swingable between a first position and a second position, the positioning insertion member 2 is sleeved on the wall portion 13, and the wall portion 13 includes a supporting portion 14 on a side facing the elastic arm 26. In this embodiment, when the positioning insertion member 2 is in the first position, the supporting portion 14 abuts against the other end of the elastic arm 26 so that the other end of the elastic arm 26 cannot elastically deform and retract into the main body. When the positioning insertion member 2 is in the second position, the other end of the elastic arm 26 is disengaged from the supporting portion 14, and the other end of the elastic arm 26 can elastically deform and retract into the main body due to external force.

More specifically, the wall portion 13 includes a release slot 15 on a side facing the elastic arm 26, and when the positioning insertion member 2 is in the second position, the release slot 15 corresponds to the elastic arm 26. The elastic arm 26 can elastically deform and extend in the release slot 15 under the action of external force. Moreover, regardless of whether the positioning insertion member 2 is in the first position or the second position, the wall portion 13 on the side opposite to the elastic arm 26 always abuts against the main body 23, providing support for the positioning insertion member 2, allowing the positioning insertion member 2 to swing stably.

In this embodiment, the positioning insertion member 2 is rotatably mounted on the base 1 about a reference axis 4. The opening direction of the first through hole 24 is the same as the extending direction of the reference axis 4. The extending direction of the reference axis 4 is the same as the direction in which the first pivot connection portion 21 is inserted into the second pivot connection portion 11. The release slot 15 and the supporting portion 14 are arranged adjacently along a direction perpendicular to the reference axis 4. The main body 23 includes a dodging space 25 in a direction perpendicular to the reference axis 4, and the dodging space 25 penetrates through the main body 23. The dodging space 25 is configured to accommodate a portion of the positioning insertion member 2. When the positioning insertion member 2 is in the second position, the volume of the positioning insertion member 2 in the dodging space 25 is greater than the volume of the positioning insertion member 2 in the dodging space 25 when the positioning insertion member 2 is in the first position. When the positioning insertion member 2 is in the first position, the main body 23 and the wall portion 13 are coaxially arranged, and the wall portion 13, on the side facing the dodging space 25, is inclined to the wall surface of the main body 23 where the dodging space 25 is disposed.

Preferably, the base 1 further includes an insertion slot 16, the insertion slot 16 is disposed through the base portion 12, the positioning insertion member 2 further includes a hook 28, the hook 28 is disposed on the main body 23 and is movable with the main body 23, the insertion slot 16 is located along the movement path of the hook 28, and when the main body 23 swings to the second position, the hook 28 is inserted in the insertion slot 16 and hooks onto the base portion 12 so that the main body 23 is positioned at the second position, which facilitates the user applying force to sleeve or detach the socket 3 from the positioning insertion member 2. In this embodiment, the hook 28 and the dodging space 25 are disposed on opposite sides of the main body 23 in a direction perpendicular to the reference axis 4.

Preferably, the base portion 12 includes an enlarged portion 17 on a side of the hole wall surrounding the insertion slot 16, and when the main body 23 swings to the second position, the hook 28 hooks onto the enlarged portion 17. The enlarged portion 17 not only maintains a certain structural strength to withstand the force applied by the hook 28, but also provides a larger area for the hook 28 to engage, dispersing stress and improving the stability of the hook.

Preferably, the base portion 12 further includes a second through hole 19, the second through hole 19 is adjacent to the enlarged portion 17, the enlarged portion 17 is positioned between the insertion slot 16 and the second through hole 19 in a direction perpendicular to the reference axis 4. When the hook 28 is inserted through the insertion slot 16, the second through hole 19 provides clearance space for the deformation of the enlarged portion 17, allowing the hook 28 to smoothly pass through the insertion slot 16 and hook onto the enlarged portion 17.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A socket holder including:
a base; and
a positioning insertion member swingably disposed on the base and configured for a socket to be sleeved thereon.

2. The socket holder of claim 1, wherein the positioning insertion member includes two first pivot connection portions, the two first pivot connection portions are disposed on opposite sides of the positioning insertion member, the base includes two second pivot connection portions, and the two first pivot connection portions are respectively pivotally connected to the two second pivot connection portions so that the positioning insertion member can pivotally swing relative to the base.

3. The socket holder of claim 1, wherein the positioning insertion member includes a main body and an elastic arm, the main body includes a first through hole, an end of the elastic arm is connected to the main body and extends within the first through hole, an other end of the elastic arm is a free end and includes a first positioning portion, and when the positioning insertion member is inserted in the socket, the first positioning portion is configured to be engaged with a second positioning portion of the socket.

4. The socket holder of claim 3, wherein the base includes a base portion and a wall portion, the wall portion protrudes from the base portion, the positioning insertion member is connected to the base portion and is swingable between a first position and a second position, the positioning insertion member is sleeved on the wall portion, the wall portion includes a supporting portion on a side facing the elastic arm, when the positioning insertion member is in the first position, the supporting portion abuts against the other end of the elastic arm so that the other end of the elastic arm cannot elastically deform and retract into the main body, and when the positioning insertion member is in the second position, the other end of the elastic arm is disengaged from the supporting portion, and the other end of the elastic arm can elastically deform and retract into the main body due to external force.

5. The socket holder of claim 4, wherein the wall portion includes a release slot on a side facing the elastic arm, and when the positioning insertion member is in the second position, the release slot corresponds to the elastic arm, and the elastic arm can elastically deform and extend into the release slot under external force.

6. The socket holder of claim 4, wherein the positioning insertion member is rotatable relative to the base about a reference axis, an opening direction of the first through hole is the same as the extending direction of the reference axis, the main body includes a dodging space in a direction perpendicular to the reference axis, the dodging space is configured for accommodating a portion of the positioning insertion member, and when the positioning insertion member is in the second position, a volume of the positioning insertion member in the dodging space is greater than a volume of the positioning insertion member in the dodging space when the positioning insertion member is in the first position.

7. The socket holder of claim 4, wherein the base further includes an insertion slot, the insertion slot is disposed in the base portion, the positioning insertion member further includes a hook, the hook is disposed on the main body and is movable with the main body, the insertion slot is located on a movement path of the hook, and when the main body swings to the second position, the hook is inserted into the insertion slot and hooks onto the base portion so that the main body is positioned at the second position.

8. The socket holder of claim 7, wherein the base portion includes an enlarged portion on a side of a hole wall surrounding the insertion slot, and when the main body swings to the second position, the hook hooks onto the enlarged portion.

9. The socket holder of claim 1, wherein the positioning insertion member is detachably connected to the base.

10. The socket holder of claim 5, wherein the positioning insertion member includes two first pivot connection portions, the two first pivot connection portions are disposed on opposite sides of the positioning insertion member, the base includes two second pivot connection portions, and the two first pivot connection portions are respectively pivotally connected to the two second pivot connection portions so that the positioning insertion member can pivotally swing relative to the base; the positioning insertion member is rotatable relative to the base about a reference axis, an opening direction of the first through hole is the same as the extending direction of the reference axis, the release slot and the supporting portion are arranged adjacent to each other in a direction perpendicular to the reference axis, the main body includes a dodging space in a direction perpendicular to the reference axis, the dodging space is configured for accommodating a portion of the positioning insertion member, and when the positioning insertion member is in the second position, a volume of the positioning insertion member in the dodging space is greater than a volume of the positioning insertion member in the dodging space when the positioning insertion member is in the first position; the base further includes an insertion slot, the insertion slot is disposed in the base portion, the positioning insertion member further includes a hook, the hook is disposed on the main body and is movable with the main body, the insertion slot is located on a movement path of the hook, and when the main body swings to the second position, the hook is inserted into the insertion slot and hooks onto the base portion so that the main body is positioned at the second position; the base portion includes an enlarged portion on a side of a hole wall surrounding the insertion slot, and when the main body swings to the second position, the hook hooks onto the enlarged portion; the positioning insertion member is detachably connected to the base; each of the two first pivot connection portions is a protruding column, each of the two second pivot connection portions is a pivot hole, the two first pivot connection portions are detachably inserted in the two second pivot connection portions, each of the two first pivot connection portions includes a first inclined surface, the base includes a plurality of second inclined surfaces, when the positioning insertion member is assembled to the base, and the first inclined surfaces of the two first pivot connection portions respectively slidably abut against the plurality of second inclined surfaces; the extending direction of the reference axis is the same as the direction in which the two first pivot connection portions are inserted in the two second pivot connection portions; as the positioning insertion member is either in the first position or the second position, the wall portion on a side opposite to the elastic arm abuts against the main body; the hook and the dodging space are disposed on opposite sides of the main body in a direction perpendicular to the reference axis; the base is configured to slide on a rail device; when the positioning insertion member is in the first position, the main body and the wall portion are coaxially arranged, and a side of the wall portion facing the dodging space is inclined to the wall surface of the main body where the dodging space is disposed; the dodging space penetrates through the main body; the base portion further includes a second through hole, the second through hole is adjacent to the enlarged portion, the enlarged portion is disposed between the insertion slot and the second through hole in a direction perpendicular to the reference axis, and when the hook is inserted in the insertion slot, the second through hole provides clearance space for the deformation of the enlarged portion so that the hook can smoothly pass through the insertion slot and hook onto the enlarged portion.
